(19) United States
(12) Patent Application Publication
(10) Pub. No.: US 2023/0274665 A1
(43) Pub. Date: Aug. 31, 2023

(54) DISSOLVABLE LABEL

(71) Applicant: David Schuster-Wachsberger, Kansas City, MO (US)

(72) Inventor: David Schuster-Wachsberger, Kansas City, MO (US)

(21) Appl. No.: 17/681,550

(22) Filed: Feb. 25, 2022

(51) Int. Cl. G09F 3/00; B65D 25/20; G09F 3/10; C09J 103/02; C09J 7/00; C09J 9/00

(52) U.S. Cl. CPC G09F 3/0291; B65D 25/205; G09F 3/10; C09J 103/02; C09J 7/00; C09J 9/00; G09F 2003/0202

(57) ABSTRACT

The development of the Dissolvable Labels for Medvantage® Machine fulfills this need. The Dissolvable Labels for Medvantage® Machine, as its name implies, is a line of dissolvable labels for use on a specific brand of printer. The labels would be used in a wide variety of applications including healthcare, foodservice, sterile processing, and other similar applications. They would be made available in a wide variety of sizes including but not limited to 2½″ square, ⅞″ by 1⅝″, ⅞″ by 2¼″, and similar sizes. Also, in addition to various colors, the invention would be made in various finishes such as synthetic and matte. The invention is specifically designed for use in printers manufactured by MedVantage®, although they could be adapted for use with different manufacturers as well. The use of the Dissolvable Labels for Medvantage® Machine allows for the production of labels that can be removed at a later time in a manner which is not only quick, easy, and effective, but ecologically and economically friendly as well.

### FIELD OF THE INVENTION

This invention relates to moving systems. More particularly, it relates to moving systems with slings.

### BACKGROUND

A label is a piece of paper, plastic film, cloth, metal, or other material affixed to a container or product, on which is written or printed information or symbols about the product or item. Information printed directly on a container or article can also be considered labelling.

Labels have many uses, including promotion and providing information on a product's origin, manufacturer, use, shelf-life and disposal, some or all of which may be governed by legislation. Methods of production and attachment to packaging are many and various and may also be subject to internationally recognized standards. In many countries, hazardous products such as poisons or flammable liquids must have a warning label.

Labels may be used for any combination of identification, information, warning, instructions for use, environmental advice or advertising. They may be stickers, permanent or temporary labels or printed packaging.

Labels for food and beverages as well as medical applications typically include critical information pertinent to the contents or ingredients used in a product. The FDA as well as the Health Insurance Portability and Accountability Act (HIPAA) provides standards to regulate the information provided on the labels and packaging of these uses.

Laser or printer labels are generally die cut on 8.5″×11″ (US letter) or A4 sized sheets, and come in many different shapes, sizes, formats, and materials. Laser label material is a nonporous stock made to withstand the intense heat of laser printers and copiers. A drawback of laser labels is that the entire sheet needs to be printed before any labels are used; once labels have been removed the sheet cannot be put through the printer again without damaging the printing mechanism. Inkjet label material is a porous stock made to accept ink and dye from an inkjet printer. One of the more modern inkjet label material stocks is waterproof printable inkjet material commonly used for soap or shower gel containers.

Antimicrobial labels. With the growth in hospital acquired infections such as MRSA and E-Coli the use of antimicrobial labels in infection sensitive areas of hospitals are helping in combating these types of microbes.

Label “stock” is the carrier which is commonly coated on one side with adhesive and printed on the other, and can be: Paper—a variety of papers and paperboards can be used as labels, Nonwoven fabric—for extra durability, Latex—a lithographic stock with some added latex allows the label to be much more flexible and form around certain curved objects more easily than standard paper, Foil—Aluminum foil and vapor-coated plastic films are often chosen for the bright reflective characteristics; Thermal—direct thermal label stock will change color (usually black) when heated. A heating element in the shape of letters or images can be used to create an image on the label. Custom labels can easily be made on location in this way. A disadvantage is durability, because another heat source can ruin or obscure the image, or it may fade completely over time. Thermal transfer for applications that cannot use thermal (thermal direct) label material because of heat source proximity or short label life, a more widely used material is the thermal transfer label printer. This material has the advantage of a much longer readable life and does not fade with time or heat. Most major manufacturers of thermal printers can be used for either thermal transfer (TT) or thermal (DT) labels. A thermal transfer ribbon will be required to print the labels. The cost of the ribbons+TT labels is similar to that of the DT labels on their own.

The stock type will affect the types of ink that will print well on them. Corona treating or flame treating some plastics makes them more receptive to inks, coatings, and other substrates by reducing surface tension and improving overall adhesion of the plastics.

Pressure-sensitive label adhesives are commonly made from water-based acrylic adhesives, with a smaller volume made using solvent-based adhesives and hotmelt adhesives. The most common adhesive types are: Peelable—Adhesion is fairly strong and will not fall off in normal circumstances, but the label can be removed relatively easily without tearing the base stock or leaving adhesive behind on the old surface. The adhesive is usually strong enough to be applied again elsewhere. This type is frequently known as ‘removable’. There are many different types of removable adhesives, some are almost permanent, some are almost ‘ultra peelable’. Ultra-peelable—Designed principally for use on book covers and glass, when removed these adhesives labels do not leave any residue whatsoever. Adhesion is weak and only suitable for light duty applications. Normally these labels have very little adhesion to anything once they've been removed.

There are instances in the medical and/or foodservice industry where the container is washed and reused, due to cost and/or size of the container. In any case, the label still needs to be removed due to security reasons, the Health Insurance Portability and Accountability Act (HIPAA), or simply to prevent confusion on subsequent use. Labels may be peeled off with one's fingernail which typically results in label remnants and adhesive left behind. Scrapers can be enlisted but often result in damage to the container. Finally, solvents can be used, but not work in all cases. Additionally, all of these methods take time and money. Manufacturers have responded with dissolvable labels which dissolve in safe liquids such as water. However, such labels are not available for all label printers such as the MedVantage® machine.

Accordingly, and in light of the foregoing, there exists a need for a means by which disposable labels for specific label printers can be provided to address the needs described above.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front view of the dissolvable label 10, according to the preferred embodiment of the present invention;

FIG. 2 is a front view of the dissolvable label 10, in a continuous format, according to the preferred embodiment of the present invention;

FIG. 3 is a sectional view of the dissolvable label 10, as seen along a line I-I, as shown in FIG. 1, according to the preferred embodiment of the present invention; and,

FIG. 4 is a pictorial view of the dissolvable label 10 shown in a utilized state, according to the preferred embodiment of the present invention.

### DESCRIPTIVE KEY

10 dissolvable label
15 exterior surface
20 indicia
25 backing material
30 adhesive
35 label base material
40 container
45 foodstuff

### DESCRIPTION OF THE PREFERRED EMBODIMENTS

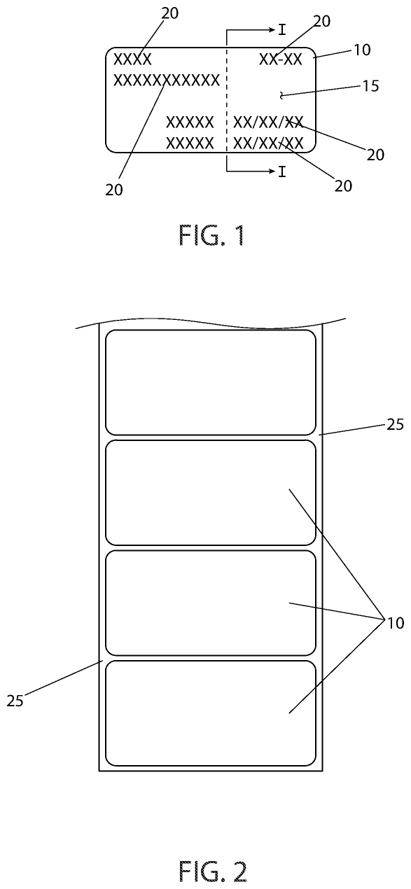

The best mode for carrying out the invention is presented in terms of its preferred embodiment, herein depicted within FIGS. 1 through 4. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### 1. DETAILED DESCRIPTION OF THE FIGURES

Referring now to FIG. 1, a front view of the dissolvable label 10, according to the preferred embodiment of the present invention is disclosed. The dissolvable label 10 (herein also described as the “label”) 10, are particularly used to label reusable containers 40 used in healthcare, foodservice, food manufacturing, sterile processing, and other similar applications. The label 10 would be provided with an exterior surface 15 upon which indicia 20 is printed. The indicia 20, envisioned to include the name of the product within the container upon which the label 10 is placed, the date it was made, the date it is scheduled to expire, and the initials of whomever produced that product, would be printed manually or via an automatic printer such as the Intellidate machine by Medvantage®. It is noted that the method of producing the indicia 20 is not intended to be a limiting factor of the present invention. The label 10 would be produced in a wide variety of colors, tints, and hues to suit widely varied applications. The exterior surface 15 would also be produced in various finishes such as synthetic and matte. It is noted that any specific color of finish is not intended to be a limiting factor of the present invention.

Referring next to FIG. 2, a front view of the label 10, in a continuous format, according to the preferred embodiment of the present invention is depicted. The continuous format would ideally be used in an automatic printing process used in a programmable printer or printer connected to a computer. The label 10 is attached to a backing material 25 that allows for easy removal of the label 10. The method of attachment used between individual label 10 or sections of label 10 to produce the continuous feed arrangement are envisioned to include roll, fan-fold, tractor-fed (with side holes) or the like. The exact material used to produce the backing material 25 and the method of continuous feed arrangement is not intended to be a limiting factor of the present invention. The size of the label 10 may be varied as to the individual need. Typical sizes are envisioned to include square labels at two and one-half inches (2½ in.) square, and rectangular labels at seven-eighths of an inch (⅞ in.) by one and five-eighths of an inch (1⅝ in.) and seven-eighths of an inch (′/8 in.) by two and one-quarter inches (2¼ in.). The exact size of the label 10 is not intended to be a limiting factor of the present invention.

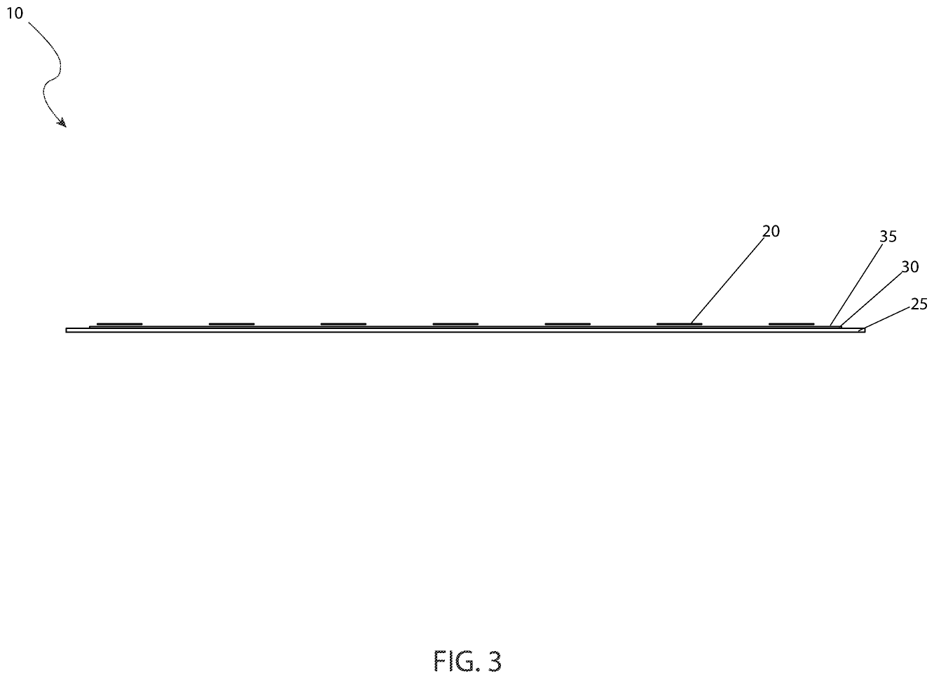

Referring now to FIG. 3, a sectional view of the label 10, as seen along a line I-I, as shown in FIG. 1, according to the preferred embodiment of the present invention. is shown. The backing material 25 is located at the bottom of the label 10. Immediately above the backing material 25 is a water-based adhesive 30 that will dissolve in the presence of water. The adhesive 30 is located on the bottom of a label base material 35. The label base material 35 is also made of a water dissolvable material. Possible materials of construction include but are not limited to: a corn-based material, a corn and rice material, a corn and potato material, or the like. Other possible food grade materials would include tapioca, potato, arrowroot, sorghum, cauliflower or cassava. Papier-mâché material may also be included as a material of manufacture. The label base material 35 would be extracted from raw materials, thus producing a starch. It would then be mixed into a malleable form, spread into a thin layer and allowed to dry. Finally, it would be cut to into the needed sizes as described above. The adhesive 30 would be applied and then adhered to the backing material 25. During the printing process by the final user, the indicia 20 would be placed upon the adhesive 30.

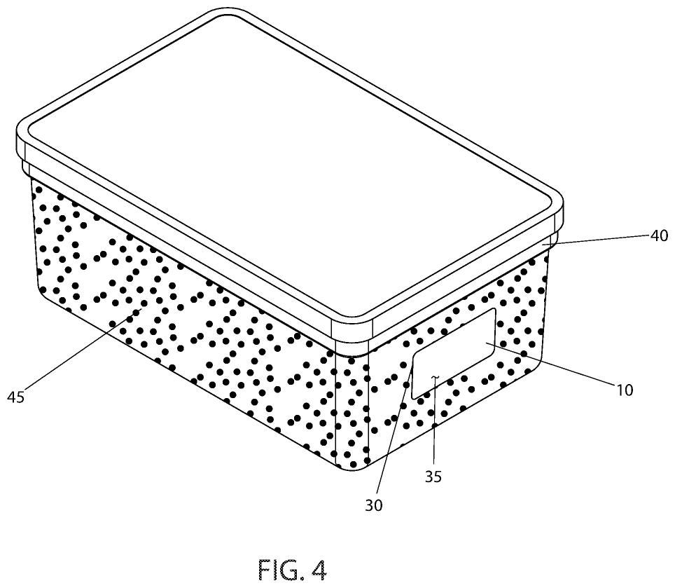

Referring to FIG. 4, a pictorial view of the label 10 shown in a utilized state, according to the preferred embodiment of the present invention is disclosed. The label 10 is depicted upon a container 40 envisioned to contain food stuffs 45 for purposes of illustration. As the container 40 is desired to be labeled as to its contents and other information as described above, the label 10 provides such an information label. The container 40 is a reusable container that is washed and sanitized between different uses. The use of the container 40 after washing and sanitization will be different, thus requiring a different label 10. To assist in this process, the label 10 is removed completely during the washing process. Said washing process would completely remove any and all label base material 35 and adhesive 30, along with any remaining foodstuffs 45, contaminants, dirt, debris or the like. As the label base material 35 and the adhesive 30 are completely dissolved in water, the remnants can be simply washed down the discharge drain without worry of generating blockages.

### 2. OPERATION OF THE PREFERRED EMBODIMENT

The preferred embodiment of the present invention can be utilized by the common user in a simple and effortless manner with little or no training. It is envisioned that the label 10 would be constructed in general accordance with FIG. 1 through FIG. 4. The user would procure the label 10 from conventional procurement channels such as food supply services, mail order and internet supply houses and the like. Special attention would be paid to the material used to manufacture the label base material 35, the size, color, and finish of the exterior surface 15, method of continuous feed used with backing material 25 and the like.

After procurement and prior to utilization, the label 10 would be prepared in the following manner: in the case of manual printing via a pen, the user would simply write upon the label base material 35 as required to produce the indicia 20. The indicia 20 is envisioned to include name of the foodstuffs 45, date of production, date of expiration, identifying of person or team who produced the foodstuffs 45 and the like.

During utilization of the label 10, the following procedure would be initiated: the label 10 with necessary indicia 20 are applied to container 40 containing various foodstuffs 45. The processing of the foodstuffs 45 and container 40 then continue in normal process until the cleaning process of the container 40 occurs.

During the cleaning process, the empty container 40 is placed is washed in a manual process, such as in a sink, or in an automatic process such as in a dishwasher. The washing process envisioned to include hot water, soap, agitation, and a rinsing process will dissolve the label 10 along with the adhesive 30 in their entirety. At this point in time, the container 40 is ready for reuse with another newly printed label 10.

Features of the label 10 are envisioned to provide the following benefits. Ecological and environmentally friendly method of discarding used labels 10 and its associated water based adhesive 30, usage for manual printing, usage for automatic printing in a printer produced by Medvantage®, total dissolving when exposed to water, the elimination of potentially hazardous solvents, elimination of potential confusion from remnants of old labels that are remaining on a container 40, the reuse of container 40 in various fields of commerce thereby reducing waste in landfills, and the production of a “green” product that reduces usage of new materials and associated wasted materials.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A dissolvable label for labeling a container or other product, the label consisting of:
a backing material, the backing material coupled to a bottom of the label;
an adhesive, the adhesive being applied to the backing material of the label;
a label base material, wherein the adhesive is coupled to a bottom of the label base material, wherein the label base material is a water dissolvable material, the water dissolvable material being at least one of: a corn-based material, a corn and rice-based material, a corn and potato-based material, a sorghum-based material and a tapioca-based material; and
an indicia, the indicia being printed on the adhesive on the backing material of the label.

2. The label according to claim 1, wherein the label has a square shape.

3. The label according to claim 2, wherein the label being two and one-half inch in width.

4. The label according to claim 2, wherein the label being two and one-half inch in length.

5. The label according to claim 1, wherein the label is a rectangular shape.

6. The label according to claim 5, wherein the label being one and five-eighths inches (1⅝″) in length.

7. The label according to claim 5, wherein the label being seven eighths inches (⅞″) in width.

8. The label according to claim 5, wherein the label being two and one-fourth inches (2¼″) in length.

9. (canceled)

10. (canceled)

11. (canceled)

12. (canceled)

13. (canceled)

14. (canceled)

15. The label according to claim 9, wherein the label-based material being extracted from raw materials, wherein the extracted raw material producing a starch.

16. The label according to claim 1, wherein the adhesive material being applied to the label and adhered to the backing material.

17. (canceled)

18. The label according to claim 1, wherein the indicia being written by one of a printer, manually and a combination of printer and manually.

19. The label according to claim 18, wherein the indicia having a foodstuff name, a date of production, a date of expiration and an identification of a producer of the foodstuff.

20. The label according to claim 1, wherein the label being removable by soap and water.
